(19) United States
(12) Patent Application Publication
(10) Pub. No.: US 2010/0088312 A1
(43) Pub. Date: Apr. 8, 2010

(54) Real-Time Radio Station Audio Content Search and Delivery

(75) Inventor: Jason Goldfeder, Memphis, TN (US)

Correspondence Address: WILSON, SONSINI, GOODRICH & ROSATI, 650 PAGE MILL ROAD, PALO ALTO, CA, 94304-1050, US

(73) Assignee: RADIOSTATIONS, INC., Memphis, TN (US)

(21) Appl. No.: 12/574,964

(22) Filed: Oct. 7, 2009

Related U.S. Application Data
(60) Provisional application No. 61/103,792, filed on Oct. 8, 2008.

(51) Int. Cl. G06F 17/30

(52) U.S. Cl. 707/732; 707/E17.009

(57) ABSTRACT

Disclosed are systems and methods distributing and/or recommending real-time radio. More specifically, it relates to methods for providing information of real-time radio songs and methods for recommending at least one real-time radio songs to a particular user. Methods are provided for switching to a real-time radio song based on the preferences of a user. Systems for collecting the preferences of a user and recommending at least one real-time radio song to the user or switching to a real-time radio song based on the preferences of a user are also disclosed.

### CROSS-REFERENCE

This application claims the benefit of U.S. Provisional Application No. 61/103,792, filed Oct. 8, 2008, which is incorporated herein by reference in its entirety.

### BACKGROUND OF THE INVENTION

Radio Stations are no longer limited to AM and FM stations. Audio content can now be delivered through other mediums such as (but not limited to) television, HD television, Digital television, Satellite Radio (such as Sirius and/or XM), and Internet Streaming Radio. With the use of new technology to deliver media of all kinds, Radio Stations (e.g., AM, FM, HD, Sirius XM, Satellite Radio, Internet Streaming Radio, etc.) have started expanding and making their audio content available via the Internet and other networks.

### SUMMARY OF THE INVENTION

As Radio Stations (e.g., AM, FM, HD, Sirius XM, Satellite Radio, Internet Streaming Radio, etc.) expand and make their audio content available via the Internet and other networks, it is possible to aggregate and deliver this content in new and compelling ways. This invention crawls real-time and static data feeds (e.g., XML, JSON, proprietary, etc.) that describe the audio content being played (e.g., song, artist, etc.) on online radio sources. It then stores, aggregates, and renders the data and information about available audio content that is able to be consumed. The invention is then able to provide search capabilities into the audio content being played in either a static or dynamic manner. The search results can be rendered in a variety of ways including a browser, mobile phone, car, or other device and presented in multiple formats such as audio, text, and graphics. Furthermore, by collecting the preferences of the listener, and ratings of other listeners, the invention can automatically switch radio stations or notify the listener (via sound, popup, etc.) that desired content is being played. Each listener can have a unique listening experience based on his/her preferences. The listener can choose to only listen to a specific artist, song, genre, and/or date range of release (e.g., “the eighties”), as well as have audio content recommended to him/her. It keeps track of new audio content and how many times a particular song is played across all audio content platforms. It also makes listeners aware of radio stations that they would not have found otherwise, a feature that can be beneficial to internet radio businesses since it can help them build their audiences.

The present invention relates to systems and methods for distributing and/or recommending real-time radio. More specifically, it relates to methods for providing information of real-time radio songs and methods for recommending at least one real-time radio songs to a particular user. Methods are also provided for switching to a real-time radio song based on the preferences of a user. Systems for collecting the preferences of a user or other people, including users of the system and/or non-users of the system, and recommending at least one real-time radio song to the user or switching to a real-time radio song based on the preferences of a user are also disclosed.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommendation list comprising a subset of the accessible real-time radio songs.

Methods provided herein may include choosing the real-time radio song for the user, recommending the real-time radio song to the user, allowing the user to choose whether to interrupt the current song being listened to in favor of a recommended real time radio song (or a set/subset of recommended real-time radio songs), and allowing the user to choose whether to interrupt the current song being listened to in favor of a another un-named real time radio song having a desirable preference value. The user may also and/or alternatively be allowed to decline interruption of the current song being listened to. Allowing decline of interruption may comprise allowing inaction by the user. The user need not actually decline, rather, the user may simply abstain from allowing interruption, which may be considered the same as declining herein.

The preference value for each of the accessible real-time radio songs may be based on, for non-limiting example: the ratings of multiple people (including users and/or non-users), preferences values for each song from a plurality of people (including users and/or non-users), pre-established ratings for the songs (including ratings by the user, by other users, by non-users, or computer-generated ratings), ratings based on genre (by the user, by other users, by non-users, and/or computer-generated ratings), ratings based on artist (by the user, by other users, by non-users, and/or computer-generated ratings), ratings based on release date (by the user, by other users, by non-users, and/or computer-generated ratings), ratings based on popularity (by the user, by other users, by non-users, and/or computer-generated ratings), ratings based on most-listened to songs (by the user, by other users, by non-users, and/or computer-generated ratings), and signal strengths of the accessible real-time radio songs.

In some embodiments of the methods provided herein, the subset of the accessible real-time radio songs may comprise those accessible real-time radio songs having the highest determined preference values. The subset of the accessible real-time radio songs may comprise songs that at least one of: are within a specified genre, are by a specified artist, are within a specified playlist, and have at least a minimum preference value. Accessible real-time radio songs may include those which require an account to access, such as, for non-limiting example, a song playing on an XM satellite radio channel. Determining whether a song is accessibly may include verifying the user has an active account (or subscription) with a particular radio station playing the real-time radio song.

In one aspect are methods of providing at least one real-time radio song for a user, comprising,

(a) receiving information of a first real-time radio song using a data management engine;

(b) determining a first preference value for said first real-time radio song using a personalization and preferences engine, wherein the personalization and preferences engine allows a user to input rating data used for determining the preference value; and

(c) based on the preference value of the first real-time radio song, at least one of:
(i) recommending the user to switch to the first real-time radio song,
(ii) automatically switching the song being listened to by the user to the first real-time radio song, and
(iii) repeating steps (a), (b), and (c) for a second real-time radio song.

In some embodiments, the steps of recommending, switching, and repeating are based on whether the preference value for the first real-time radio song meets a threshold preference value. The threshold preference value may comprise a level of desirability set by a user, such as a rating, for non-limiting example. The threshold preference value may be a value set, for non-limiting example, based on user ratings of other songs by the same artist, based on user ratings of other songs in the same genre, based on user ratings of other songs ratings by other users, based on ratings of the real-time radio song by other users, based on ratings of the real-time radio song by non-users, or any combination thereof. The threshold preference value may be one of the top 10%, top 20%, top 25%, top 30%, top 33%, top 40%, top 50%, top 60%, top 66%, top 70%, and top 75% of all preference values of all songs established for the user based on the user's ratings. The threshold preference value may be one of the top 10%, top 20%, top 25%, top 30%, top 33%, top 40%, top 50%, top 60%, top 66%, top 70%, and top 75% of all preference values of all songs in the data management engine, whether rated by the user or not. The threshold preference value may factor into its value the time remaining for each real-time radio song, such that songs having more time remaining (in absolute terms, and/or as a percentage of the total song time), are rated higher than a song having less time remaining (again, in absolute terms, and/or as a percentage of the total song time).

Automatically switching the song being listened to may include prompting the user with a choice to switch to an un-named real-time radio song having a desirable preference value, such as a preference value meeting a threshold preference value as noted herein. The method provided may comprise offering to interrupt the song being listened to, and upon acceptance of such offer, switching to the real-time radio song having a desirable preference value. The user may also and/or alternatively be allowed to decline interruption of the current song being listened to. Allowing decline of interruption may comprise allowing inaction by the user. The user need not actually decline, rather, the user may simply abstain from allowing interruption, which may be considered the same as declining herein.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommendation list comprising the accessible real-time radio songs in a pre-determined preference value order of the of the accessible real-time radio songs.

The pre-determined preference value order may be, for non-limiting example, alphabetical, by date of release, by popularity, by genre, by artist, by user setting, by interest rating of the user, and/or by time remaining in song.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommended real-time radio song having the highest determined preference value of the accessible real-time radio songs.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) automatically switching the song being listened to, if any, to the real-time radio song having the highest determined preference value of the accessible real-time radio songs.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) automatically switching the song being listened to, if any, to one of the accessible real-time songs in the subset of the accessible real-time radio songs having the highest determined preference values.

In some embodiments of the methods provided herein, the subset of the accessible real-time radio songs may comprise those accessible real-time radio songs having the highest determined preference values. The subset of the accessible real-time radio songs may comprise songs that at least one of: are within a specified genre, are by a specified artist, are within a specified playlist, and have at least a minimum preference value.

In some embodiments of the methods provided herein, automatically switching the song automatically changes the radio station for the user.

In some embodiments, the data management engine is enabled to obtain information via a network. In some embodiments, the network is internet. In some embodiments, said network allows real-time radio data feed.

In some embodiments of this aspect, said data management engine and said personalization and preferences engine are enabled under an operation system within a computer server. In some embodiments, said data management engine comprises a data collection module and an output module. In some embodiments, the data collection module collects real-time radio data and filters the collected data if necessary. In some embodiments, the output module feeds information into said at least one database. In some embodiments, said data management engine is enabled to deliver information into at least one database.

In some embodiments of this aspect, said methods use at least one database. In some embodiments, said at least one database comprises, (a) a song database; and (b) an artist database. In some embodiments, wherein said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said methods are performed using a system comprising,
(a) a network;
(b) at least one computer server;
(c) a data management engine for obtaining information on real-time radio;
(d) at least one database;
(e) a personalization and preferences engine; and
(f) an interface for a user for accessing real-time radio information based on geographical information.

In another aspect are methods for choosing a real-time radio song for a user, comprising,
(a) enabling a user to create a user account on at least one computer server;
(b) enabling the user to access real-time radio information based on geographical information using a network;
(c) enabling the user to provide rating data for at least one song played on the radio via an interface;
(d) determining a preference value for each of at least one real-time radio song using a personalization and preferences engine based on the rating data; and
(e) determining whether to recommend the at least one real-time radio song to the user based on the preference value.

In some embodiments of this aspect, wherein said at least one computer server comprises an operation system for running said data management engine and said personalization and preferences engine. In some embodiments, said network in the internet. In some embodiments, said network allows real-time radio data feed. In some embodiments, the real-time radio information is obtained using a data management engine.

In some embodiments of this aspect, said methods are performed using a data management engine. In some embodiments, said data management engine comprises a data collection module and an output module. In some embodiments, the data collection module collects real-time radio data and filters the collected data if necessary. In some embodiments, the output module feeds information into at least one database.

In some embodiments of this aspect, said methods use at least one database. In some embodiments, said at least one database comprises, (a) a song database; and (b) an artist database. In some embodiments, said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said methods are performed using a system comprising,
(a) a network;
(b) at least one computer server;
(c) a data management engine for obtaining information on real-time radio;
(d) at least one database;
(e) a personalization and preferences engine; and
(f) an interface for a user for accessing real-time radio information based on geographical information.

In another aspect are methods for providing a real-time radio song for a user, comprising,
(a) receiving information of a first real-time radio song using a data management engine;
(b) determining whether the first real-time radio song is accessible to said user;
(c) if the first real-time radio song is accessible to said user, determining a first preference value for said first real-time radio song using a personalization and preferences engine;
(d) determining a second preference value for a second real-time radio song that the user is listening to;
(e) comparing the first preference value to the second preference value; and
(f) if the first preference value is higher than the second preference value, recommending the user to switch to the first real-time radio song and/or automatically switching the song being listened to by the user to the first real-time radio song.

In some embodiments of the methods provided herein, if first preference value is lower than the second preference value, the method comprises allowing the user to continue listening to the second real-time radio song which the user is listening. If first preference value is lower than the second preference value, the method may further comprise: (a) receiving information of a third real-time radio song using a data management engine; (b) determining whether the third real-time radio song is accessible to said user; (c) if the third real-time radio song is accessible to said user, determining a third preference value for said third real-time radio song using a personalization and preferences engine; (d) comparing the second preference value to the third preference value; and (f) if the second preference value is higher than the third preference value, recommending the user to switch to the third real-time radio song and/or automatically switching the song being listened to by the user to the third real-time radio song. The step of automatically switching the song being listened to may occur at the end of the second real-time radio song.

In another further aspect are systems for choosing a real-time radio song for a user, comprising,

(a) a network;

(b) at least one computer server;

(c) a data management engine for obtaining information on real-time radio;

(d) at least one database;

(e) a personalization and preferences engine; and

(f) an interface for a user for accessing real-time radio information based on geographical information.

In some embodiments, said network is the internet. In some embodiments, said network allows real-time radio data feed. In some embodiments, said at least one computer server comprises an operation system for running said data management engine and said personalization and preferences engine.

In some embodiments of this aspect, said data management engine comprises a data collection module and an output module. In some embodiments, the data collection module collects real-time radio data and filters the collected data if necessary. In some embodiments, the output module feeds information into said at least one database.

In some embodiments of this aspect, said systems comprise at least one database. In some embodiments, said at least one database comprises, (a) a song database; and (b) an artist database. In some embodiments, said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said interface allows a user to input rating data, wherein the rating data is used by the personalization and preferences engine for determining preference value for the user. In some embodiments, said preference value is used for recommending a real-time radio song to a user. In some embodiments, said preference value may be used for switching a real-time radio song for a user. Where the user is not listening to a real-time radio song initially, for non-limiting example, when the user has just turned on the radio or which may be broadcasting a commercial, news, weather updates, or a DJ speaking, the preference value may be used for tuning to a real-time radio song having a desirable preference value—which idea is encompassed in the idea of switching the real-time radio song for a user using a preference value,

In some embodiments of the above aspects, the methods or systems disclosed do not stream audio content or provide audio content. In some embodiments of the above aspects, the methods or systems disclosed do not use or contain a mobile device. In some embodiments of the above aspects, the methods or systems disclosed do not use or contain wireless communication. In some embodiments of the above aspects, the methods or systems disclosed do not ask a user to input a user profile.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

The invention is illustrated in the figures of the accompanying drawings, which are meant to be exemplary and not limiting, and in which like references are intended to refer to like or corresponding things.

FIG. 1 is a flowchart depicting an exemplary system of the present invention.

FIG. 2 is a flowchart depicting an exemplary method of the present invention.

### DETAILED DESCRIPTION OF THE INVENTION

As Radio Stations (AM, FM, HD, Sirius, XM, Satellite Radio, Internet Streaming Radio, etc.) expand and make their product available via the Internet, it is possible to aggregate and deliver this content in new and compelling ways. The Internet and other network systems are becoming more widely adopted and provide new delivery points to the listener. This invention crawls real-time and static data feeds (XML, JSON, proprietary, etc) containing the content being played (song, artist, etc), storing and aggregating the data, and renders all available audio content that is able to be consumed. The invention is then able to provide meta-search capabilities into audio content being played in real-time and render it to the user via a browser, mobile phone, car, etc. Furthermore, by collecting the preferences of the listener, and ratings of other listeners, the invention can automatically switch radio stations or notify the listener (via sound, popup, etc) that desired content is being played. Every listener has a completely unique listening experience based on their preferences. The listener can choose to only listen to specific artist, song, genre, date range of release (the eighties), as well as have audio content recommended to them. It keeps track of new audio content and how many times a particular song is played across all audio content platforms. It also drives listeners to radio stations that they would not have found otherwise. Alternatively, by using this data and the preferences of the listener, it can switch to audio content that is more preferable to the user.

The present invention relates to systems and methods for distributing and/or recommending real-time radio. More specifically, it relates to methods for providing information of real-time radio songs and methods for recommending at least one real-time radio songs to a particular user. Methods are also provided for switching to a real-time radio song based on the preferences of a user. Systems for collecting the preferences of a user or other people, including users of the system and/or non-users of the system, and recommending at least one real-time radio song to the user or switching to a real-time radio song based on the preferences of a user are also disclosed.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommendation list comprising a subset of the accessible real-time radio songs.

Methods provided herein may include choosing the real-time radio song for the user, recommending the real-time radio song to the user, allowing the user to choose whether to interrupt the current song being listened to in favor of a recommended real time radio song (or a set/subset of recommended real-time radio songs), and allowing the user to choose whether to interrupt the current song being listened to in favor of a another un-named real time radio song having a desirable preference value. The user may also and/or alternatively be allowed to decline interruption of the current song being listened to. Allowing decline of interruption may comprise allowing inaction by the user. The user need not actually decline, rather, the user may simply abstain from allowing interruption, which may be considered the same as declining herein.

The preference value for each of the accessible real-time radio songs may be based on, for non-limiting example: the ratings of multiple people (including users and/or non-users), preferences values for each song from a plurality of people (including users and/or non-users), pre-established ratings for the songs (including ratings by the user, by other users, by non-users, or computer-generated ratings), ratings based on genre (by the user, by other users, by non-users, and/or computer-generated ratings), ratings based on artist (by the user, by other users, by non-users, and/or computer-generated ratings), ratings based on release date (by the user, by other users, by non-users, and/or computer-generated ratings), ratings based on popularity (by the user, by other users, by non-users, and/or computer-generated ratings), ratings based on most-listened to songs (by the user, by other users, by non-users, and/or computer-generated ratings), and signal strengths of the accessible real-time radio songs.

In some embodiments of the methods provided herein, the subset of the accessible real-time radio songs may comprise those accessible real-time radio songs having the highest determined preference values. The subset of the accessible real-time radio songs may comprise songs that at least one of: are within a specified genre, are by a specified artist, are within a specified playlist, and have at least a minimum preference value. Accessible real-time radio songs may include those which require an account to access, such as, for non-limiting example, a song playing on an XM satellite radio channel. Determining whether a song is accessibly may include verifying the user has an active account (or subscription) with a particular radio station playing the real-time radio song.

In one aspect are methods of providing at least one real-time radio song for a user, comprising,

(a) receiving information of a first real-time radio song using a data management engine;

(b) determining a first preference value for said first real-time radio song using a personalization and preferences engine, wherein the personalization and preferences engine allows a user to input rating data used for determining the preference value; and

(c) based on the preference value of the first real-time radio song, at least one of:
(i) recommending the user to switch to the first real-time radio song,
(ii) automatically switching the song being listened to by the user to the first real-time radio song, and
(iii) repeating steps (a), (b), and (c) for a second real-time radio song.

In some embodiments, the steps of recommending, switching, and repeating are based on whether the preference value for the first real-time radio song meets a threshold preference value. The threshold preference value may comprise a level of desirability set by a user, such as a rating, for non-limiting example. The threshold preference value may be a value set, for non-limiting example, based on user ratings of other songs by the same artist, based on user ratings of other songs in the same genre, based on user ratings of other songs ratings by other users, based on ratings of the real-time radio song by other users, based on ratings of the real-time radio song by non-users, or any combination thereof. The threshold preference value may be one of the top 10%, top 20%, top 25%, top 30%, top 33%, top 40%, top 50%, top 60%, top 66%, top 70%, and top 75% of all preference values of all songs established for the user based on the user's ratings. The threshold preference value may be one of the top 10%, top 20%, top 25%, top 30%, top 33%, top 40%, top 50%, top 60%, top 66%, top 70%, and top 75% of all preference values of all songs in the data management engine, whether rated by the user or not. The threshold preference value may factor into its value the time remaining for each real-time radio song, such that songs having more time remaining (in absolute terms, and/or as a percentage of the total song time), are rated higher than a song having less time remaining (again, in absolute terms, and/or as a percentage of the total song time).

Automatically switching the song being listened to may include prompting the user with a choice to switch to an un-named real-time radio song having a desirable preference value, such as a preference value meeting a threshold preference value as noted herein. The method provided may comprise offering to interrupt the song being listened to, and upon acceptance of such offer, switching to the real-time radio song having a desirable preference value. The user may also and/or alternatively be allowed to decline interruption of the current song being listened to. Allowing decline of interruption may comprise allowing inaction by the user. The user need not actually decline, rather, the user may simply abstain from allowing interruption, which may be considered the same as declining herein.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommendation list comprising the accessible real-time radio songs in a pre-determined preference value order of the of the accessible real-time radio songs.

The pre-determined preference value order may be, for non-limiting example, alphabetical, by date of release, by popularity, by genre, by artist, by user setting, by interest rating of the user, and/or by time remaining in song.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) presenting the user with a recommended real-time radio song having the highest determined preference value of the accessible real-time radio songs.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) automatically switching the song being listened to, if any, to the real-time radio song having the highest determined preference value of the accessible real-time radio songs.

In one aspect are methods of providing at least one real-time radio song for a user, comprising:

(a) receiving information on a plurality of real-time radio songs using a data management engine;

(b) determining whether each of the real-time radio songs is accessible to said user;

(c) for the real-time radio songs that are accessible to said user, determining a preference value for each of the accessible real-time radio songs using a personalization and preferences engine; and

(d) automatically switching the song being listened to, if any, to one of the accessible real-time songs in the subset of the accessible real-time radio songs having the highest determined preference values.

In some embodiments of the methods provided herein, the subset of the accessible real-time radio songs may comprise those accessible real-time radio songs having the highest determined preference values. The subset of the accessible real-time radio songs may comprise songs that at least one of: are within a specified genre, are by a specified artist, are within a specified playlist, and have at least a minimum preference value.

In some embodiments of the methods provided herein, automatically switching the song automatically changes the radio station for the user.

In some embodiments, the data management engine is enabled to obtain information via a network. In some embodiments, the network is internet. In some embodiments, said network allows real-time radio data feed.

In some embodiments of this aspect, said data management engine and said personalization and preferences engine are enabled under an operation system within a computer server. In some embodiments, said data management engine comprises a data collection module and an output module. In some embodiments, the data collection module collects real-time radio data and filters the collected data if necessary. In some embodiments, the output module feeds information into said at least one database. In some embodiments, said data management engine is enabled to deliver information into at least one database.

In some embodiments of this aspect, said methods use at least one database. In some embodiments, said at least one database comprises, (a) a song database; and (b) an artist database. In some embodiments, wherein said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said methods are performed using a system comprising,
(a) a network;
(b) at least one computer server;
(c) a data management engine for obtaining information on real-time radio;
(d) at least one database;
(e) a personalization and preferences engine; and
(f) an interface for a user for accessing real-time radio information based on geographical information.

In another aspect are methods for choosing a real-time radio song for a user, comprising,
(a) enabling a user to create a user account on at least one computer server;
(b) enabling the user to access real-time radio information based on geographical information using a network;
(c) enabling the user to provide rating data for at least one song played on the radio via an interface;
(d) determining a preference value for each of at least one real-time radio song using a personalization and preferences engine based on the rating data; and
(e) determining whether to recommend the at least one real-time radio song to the user based on the preference value.

In some embodiments of this aspect, wherein said at least one computer server comprises an operation system for running said data management engine and said personalization and preferences engine. In some embodiments, said network in the internet. In some embodiments, said network allows real-time radio data feed. In some embodiments, the real-time radio information is obtained using a data management engine.

In some embodiments of this aspect, said methods are performed using a data management engine. In some embodiments, said data management engine comprises a data collection module and an output module. In some embodiments, the data collection module collects real-time radio data and filters the collected data if necessary. In some embodiments, the output module feeds information into at least one database.

In some embodiments of this aspect, said methods use at least one database. In some embodiments, said at least one database comprises, (a) a song database; and (b) an artist database. In some embodiments, said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said methods are performed using a system comprising,
(a) a network;
(b) at least one computer server;
(c) a data management engine for obtaining information on real-time radio;
(d) at least one database;
(e) a personalization and preferences engine; and
(f) an interface for a user for accessing real-time radio information based on geographical information.

In another aspect are methods for providing a real-time radio song for a user, comprising,
(a) receiving information of a first real-time radio song using a data management engine;
(b) determining whether the first real-time radio song is accessible to said user;
(c) if the first real-time radio song is accessible to said user, determining a first preference value for said first real-time radio song using a personalization and preferences engine;
(d) determining a second preference value for a second real-time radio song that the user is listening to;
(e) comparing the first preference value to the second preference value; and
(f) if the first preference value is higher than the second preference value, recommending the user to switch to the first real-time radio song and/or automatically switching the song being listened to by the user to the first real-time radio song.

In some embodiments of the methods provided herein, if first preference value is lower than the second preference value, the method comprises allowing the user to continue listening to the second real-time radio song which the user is listening. If first preference value is lower than the second preference value, the method may further comprise: (a) receiving information of a third real-time radio song using a data management engine; (b) determining whether the third real-time radio song is accessible to said user; (c) if the third real-time radio song is accessible to said user, determining a third preference value for said third real-time radio song using a personalization and preferences engine; (d) comparing the second preference value to the third preference value; and (f) if the second preference value is higher than the third preference value, recommending the user to switch to the third real-time radio song and/or automatically switching the song being listened to by the user to the third real-time radio song. The step of automatically switching the song being listened to may occur at the end of the second real-time radio song.

In another further aspect are systems for choosing a real-time radio song for a user, comprising,

(a) a network;

(b) at least one computer server;

(c) a data management engine for obtaining information on real-time radio;

(d) at least one database;

(e) a personalization and preferences engine; and

(f) an interface for a user for accessing real-time radio information based on geographical information.

In some embodiments, said network is the internet. In some embodiments, said network allows real-time radio data feed. In some embodiments, said at least one computer server comprises an operation system for running said data management engine and said personalization and preferences engine.

In some embodiments of this aspect, said data management engine comprises a data collection module and an output module. In some embodiments, the data collection module collects real-time radio data and filters the collected data if necessary. In some embodiments, the output module feeds information into said at least one database.

In some embodiments of this aspect, said systems comprise at least one database. In some embodiments, said at least one database comprises, (a) a song database; and (b) an artist database. In some embodiments, said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database. In some embodiments, said at least one database comprising, (a) a what's playing database; and (b) a station database.

In some embodiments, said personalization and preferences engine is capable of determining and displaying preference value without changing information in said at least one database. In some embodiments, said interface allows a user to input rating data, wherein the rating data is used by the personalization and preferences engine for determining preference value for the user. In some embodiments, said preference value is used for recommending a real-time radio song to a user. In some embodiments, said preference value may be used for switching a real-time radio song for a user. Where the user is not listening to a real-time radio song initially, for non-limiting example, when the user has just turned on the radio or which may be broadcasting a commercial, news, weather updates, or a DJ speaking, the preference value may be used for tuning to a real-time radio song having a desirable preference value—which idea is encompassed in the idea of switching the real-time radio song for a user using a preference value,

In some embodiments of the above aspects, the methods or systems disclosed do not stream audio content or provide audio content. In some embodiments of the above aspects, the methods or systems disclosed do not use or contain a mobile device. In some embodiments of the above aspects, the methods or systems disclosed do not use or contain wireless communication. In some embodiments of the above aspects, the methods or systems disclosed do not ask a user to input a user profile.

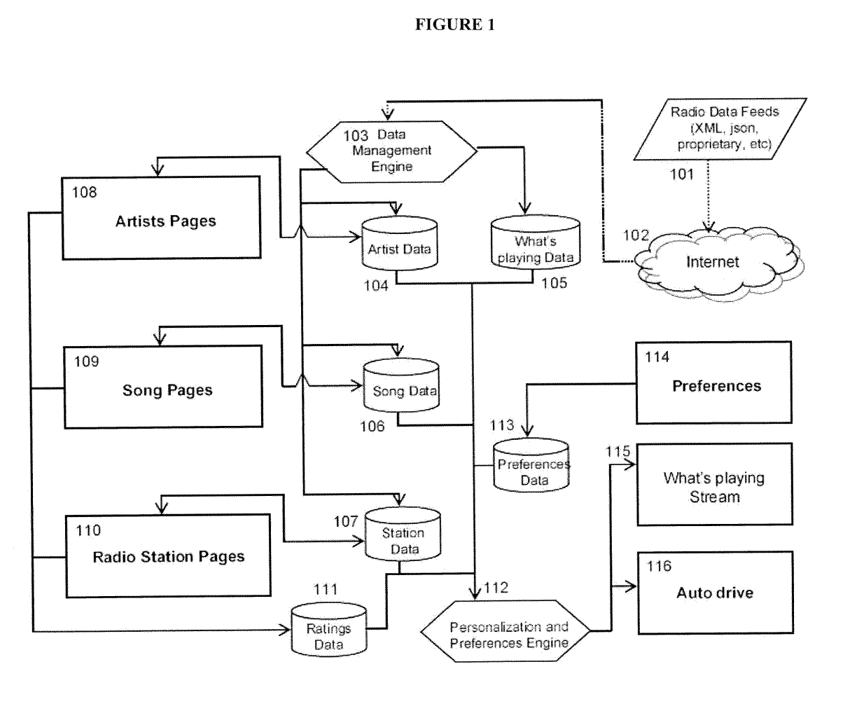

FIG. 1 shows an exemplary system for obtaining information for real-time radio from the internet and recommending a real-time radio song to a particular user.

In 101, various providers can allow real-time radio data feed via a network. The example here shows XML, json, proprietary, and other providers. In 102, the network is shown as the internet in this example. In 103, the data management engine is shown as a program residing in a computer server connected to the internet. The data management engine 103 is capable of obtaining information about real-time radio data feed from the providers as in 101. The data management engine 103 can also filter obtained information to get rid of unimportant information and retain important information. Important information can include artists, name of songs, name of radio stations, etc. In the example depicted by FIG. 1, the data management engine 103 can separate information including artists, name of songs, name of radio stations, and what's playing and place such information into different databases. The data management engine 103 can place Artist information into the Artist database 104. Similarly, the data management engine 103 can constantly update information in the what's playing database 105. The data management engine 103 can place song information (at least one of information including name of songs, length of songs, and initial publication date of songs, etc.) into a song database 106. The data management engine can also place station information into a station database 107.

The systems or methods disclosed can also comprise artists pages 108, song pages 109, and radio station pages 110. In the example depicted by FIG. 1, the artist pages 108 can allow a user to view information in the artist database 104. In embodiments, a user can access what's playing database 105 first and then access the artist pages 108 and/or artist database 104 via links provided by the system or method disclosed.

Also In the example depicted by FIG. 1, the song pages 109 can allow a user to view information in the song database 106. In embodiments, a user can access what's playing database 105 first and then access the song pages 109 and/or song database 106 via links provided by the system or method disclosed.

Also in the example depicted by FIG. 1, the radio station pages 110 can allow a user to view information in the station database 107. In embodiments, a user can access what's playing database 105 first and then access the radio station pages 110 and/or station database 107 via links provided by the system or method disclosed.

In the example depicted by FIG. 1, each of the artist pages 108, song pages 109, and radio station pages 110 may allow a user to provide rating for certain artists, songs, and radio stations, either respectively or collectively. The user's rating can be gathered into a rating database 111. Information in the rating database 111 can be used to generate preference values for artists, songs, and radio stations. Such preference values can be gathered into a preference database 113.

The systems or methods disclosed can comprise a personalization and preference engine 112. In the example depicted by FIG. 1, the personalization and preference engine 112 can gather information from the rating database 111, calculate preference values for artists, songs, and radio stations based on rating from a particular user, and place the calculated preference values into a preference database 113. Also in the example depicted by FIG. 1, a user can set up his or her own preference 114 independent of rating provided in the artist pages 108, song pages 109, and radio station pages 110. The personalization and preference engine 112 can calculate preference values based on a user's preference 114 alone or in combination with the user's rating based on information in the rating database 111. For example, a user can designate a few “preferred” radio stations or radio shows, and the systems or methods disclosed will process information from these “preferred” radio stations or radio shows first and then make recommendations accordingly.

In some embodiments, the systems or methods disclosed enables the what's playing stream function 115 for showing stream of everything playing with highlights of favorite & recommended audio content. In some embodiments, the systems or methods disclosed enables an auto drive function 116 for automatic station changing based upon user preferences.

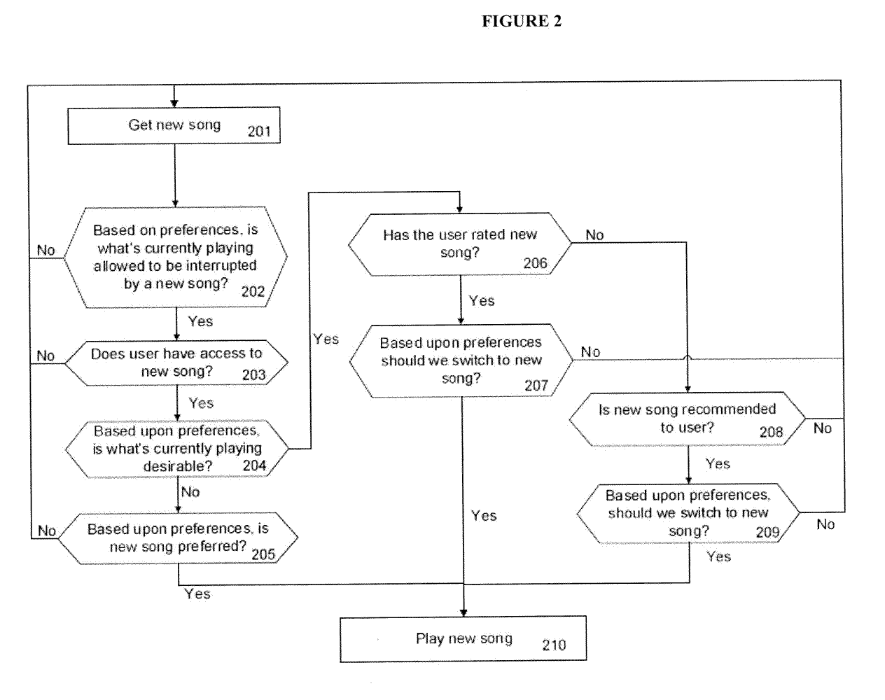

FIG. 2 shows an exemplary method for obtaining real-time radio songs and recommending new songs for a particular user.

In step 201, the exemplary method can first obtain information regarding a new song from real-time radio data feeds via the internet. The exemplary method can also obtain information regarding the song currently listened by a particular user. In step 202, the exemplary method can then determine, based on the user's preference, whether the song currently listened by the user may be interrupted by a new song. If the song currently listened by the user may not be interrupted, the exemplary method will continue to obtain information of new songs as in step 201. If the song currently listened by the user may be interrupted, the exemplary method can proceed to step 203.

In step 203, the exemplary method can determine whether the user has access to a particular new song. Such determination can be performed based on multiple factors, including physical location of the user, availability of a particular radio station in certain area, etc. If the use has access to a particular new song, the exemplary method can proceed to step 204.

In step 204, the exemplary method can determine, based on the user's preference, whether the song currently listened by the user is desirable. If the song currently listened by the user is not desirable, then the exemplary method will proceed to step 205 for recommending a new song. If the song currently listened by the user is desirable, then the exemplary method will perform a string of subsequent steps (206-209) to determine whether the system disclosed should switch to a new song for the user.

In step 205, the exemplary method can determine whether a new song is preferred by the user based on the user's preference. If the new song is preferred, then the exemplary method will switch to the new song for the user, or recommend switching to the new song for the user. If the new song is not preferred, then the exemplary method will go back to step 201 for obtaining information of another new song.

In step 206, the exemplary method can look into whether the user has rated the new song. If the user has rated the new song, then in step 207, the exemplary method will determine, based on the user's rating of the new song, whether to switch to the new song for the user, or recommend switching to the new song for the user. If the user has not rated the new song, then in step 208, the exemplary method will determine whether to recommend the new song based on the user's rating of other similar songs.

Further in step 207, if the user's rating for the new song is low, the exemplary method will not recommend the new song and will go back to step 201 for obtaining information of another new song.

Further in step 208, if the new song may be recommended based on the user's rating of other similar songs, the exemplary method will proceed to step 209 for determining whether to switch to the new song for the user. If the new song may not be recommended based on the user's rating of other similar songs, the exemplary method will not recommend the new song and will go back to step 201 for obtaining information of another new song.

Further in step 209, the exemplary method can determine whether to switch to the new song based on the user's preferences. In some embodiments, the systems or methods disclosed can automatically switch to the new song for the user. In some embodiments, the systems or methods disclosed can recommend the user to switch to the new song, and the user can switch to the new song manually.

The foregoing descriptions are not be construed to limit the scope of the invention, but rather to illustrate one preferred embodiment thereof. Other embodiments are possible, some of which are also disclosed herein. The invention is delimited only by the attached claims and their legal equivalents.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of providing at least one real-time radio song for a user, comprising:
(a) receiving information on a plurality of real-time radio songs using a data management engine;
(b) determining whether each of the real-time radio songs is accessible to said user;
(c) for the real-time radio songs that are accessible to said user, determining a preference value for each of the accessible real-time radio songs using a personalization and preferences engine; and
(d) presenting the user with a recommendation list comprising a subset of the accessible real-time radio songs.

2. The method of claim 1, comprising allowing the user to choose whether to interrupt the current song being listened to in favor of a song from the recommendation list.

3. The method of claim 1, wherein the preference value for each of the accessible real-time radio songs may be based on at least one of:
(a) user ratings,
(b) ratings of multiple users,
(c) preferences values for each song from a plurality of users,
(d) pre-established ratings for the songs,
(e) computer-generated ratings,
(f) genre,
(g) release date,
(h) popularity,
(i) most-listened to songs, and
(j) signal strengths of the accessible real-time radio songs.

4. The method of claim 1, wherein the subset of the accessible real-time radio songs comprises those accessible real-time radio songs having the highest determined preference values.

5. The method of claim 1, wherein the subset of the accessible real-time radio songs comprise songs that at least one of are within a specified genre, are by a specified artist, are within a specified playlist, have at least a minimum preference value, meet a threshold preference value.

6. The method of claim 1, wherein said data management engine is enabled to deliver information into at least one database.

7. The method of claim 6, wherein said at least one database comprises,
(a) a song database; and
(b) an artist database.

8. The method of claim 7, wherein said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database.

9. A method of choosing at least one real-time radio song for a user, comprising,
(a) receiving information of a first real-time radio song using a data management engine;
(b) determining a preference value for said first real-time radio song using a personalization and preferences engine, wherein the personalization and preferences engine allows a user to input rating data used for determining the preference value; and
(c) based on the preference value of the first real-time radio song, at least one of:
(i) recommending the user to switch to the first real-time radio song,
(ii) automatically switching the song being listened to by the user to the first real-time radio song, and
(iii) repeating steps (a), (b), and (c) for a second real-time radio song.

10. The method of claim 9, wherein the steps of recommending, switching, and repeating are based on whether the preference value for the first real-time radio song at least one of: is within a specified genre, is by a specified artist, is within a specified playlist, has at least a minimum preference value, meets a threshold preference value.

11. The method of claim 9, wherein any of the automatically switching the song steps automatically changes the radio station for the user.

12. The method of claim 9, comprising allowing the user to decline interruption of the current song being listened to.

13. A system for choosing a real-time radio song for a user, comprising,
(a) a network;
(b) at least one computer server;
(c) a data management engine for obtaining information on real-time radio;
(d) at least one database;
(e) a personalization and preferences engine; and
(f) an interface for a user for accessing real-time radio information based on geographical information.

14. The system of claim 13, wherein said network allows real-time radio data feed.

15. The system of claim 13, wherein said at least one computer server comprises an operation system for running said data management engine and said personalization and preferences engine.

16. The system of claim 13, wherein said at least one database comprises,
(a) a song database; and
(b) an artist database.

17. The system of claim 16, wherein said data management engine is capable of determining whether a real-time radio song and its artist already exist in the song database and/or the artist database; in the event of the song or its artist does not already exist in the song database and/or the artist database, the data management engine adds the new song into the song database and adds the new artist into the artist database.

18. The system of claim 13, wherein said at least one database comprises,
(a) a what's playing database; and
(b) a station database.

19. The system of claim 13, wherein said interface allows an user to input rating data, wherein the rating data is used by the personalization and preferences engine for determining preference value for the user.

20. The system of claim 13, wherein said preference value is used for switching a real-time radio song for a user.
